(19) United States
(12) Patent Application Publication
(10) Pub. No.: US 2010/0084151 A1
(43) Pub. Date: Apr. 8, 2010

(54) ELECTRICAL DEVICE WITH LOCKED-ON ROTATABLE OPERATING ELEMENT

(76) Inventors: Axel Kuhnle, Freiberg A.N. (DE); Willy Braun, Neustetten (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/519,094

(22) PCT Filed: Oct. 17, 2007
(86) PCT No.: PCT/EP2007/061048

§ 371 Date: Jun. 12, 2009

(30) Foreign Application Priority Data
Dec. 14, 2006 (DE) 10 2006 059 078.3

(51) Int. Cl. B25D 16/00

(52) U.S. Cl. 173/47; 173/217

(57) ABSTRACT

The invention relates to an electric device, and in particular to an electric hand-held machine tool, having a housing, a rotatable actuating element arranged outside the housing and a functional switch element, arranged inside the housing and connected to the actuating element in a rotationally fixed manner. According top the invention, it is provided that the actuating element and the functional switch element are locked together through an opening in the housing.

The invention relates to an electrical device, in particular a hand-guided power tool according to the preamble to claim 1.

In order to permit a switching of hand-guided electrical power tools or other electrical devices between different speeds, between different operating modes such as drilling and chiseling mode, cordless and corded operation, clockwise and counterclockwise rotation, or between other adjustable functions, the electrical devices are frequently equipped on the outside of their housing with a rotatable control or control element such as a rotary knob that is joined in a rotationally fixed manner to a functional element accommodated inside the housing, e.g. a switch cam, so that a rotation of the control element that a user executes outside the housing results in a corresponding rotation of the functional element inside the housing. The rotationally fixed connection between the control element and the functional element is usually a screw connection.

Screw connections, however, have several disadvantages: the requirement for a screw increases the number of necessary parts. If a very small screw is selected, it is in fact possible to keep the amount of space required for the screw connection to a minimum, but on the other hand, a small screw complicates the task of producing the screw connection and also requires a screw driving tool. In addition, the rotation of the control element in one rotation direction can potentially cause screw connections to loosen if special countermeasures are not taken.

Based on this, the object of the present invention is to improve an electrical device of the kind mention at the beginning such that the rotationally fixed connection between the control element situated outside the housing and the functional element situated inside the housing can be produced simply, quickly, and inexpensively, without tools and without the need for additional parts.

### DISCLOSURE OF THE INVENTION

This object is attained by virtue of the fact that the control element and the functional element are joined to each other in detent fashion through an opening of the housing.

The combination of features according to the invention makes it possible to simply, quickly, and inexpensively produce the connection between the control element and the functional element without tools and without the need for additional parts. In addition, the connection embodied in the form of a detent connection can be detached again, thus permitting a nondestructive disassembly.

A detent connection between the control element and the functional element is also more secure than a screw connection and furthermore, also requires less space, primarily if, in accordance with a preferred embodiment of the invention, a part of either the functional element or the control element protrudes through the opening of the housing into a recess of the respective other control element or functional element and in the recess, is both locked in detent fashion and secured against rotating out of position in relation to the other element.

According to a suitable embodiment, a protruding part of the functional element is inserted from the inside, through the opening of the housing, into a receiving bushing of the control element. Since the protruding part has a smaller diameter than the receiving bushing, it is thus possible to keep the opening cross section to a minimum.

In addition, it is possible to seal the opening by means of an O-ring seal with a small diameter, primarily if it encompasses the part of the functional element that protrudes through the opening of the housing; the O-ring seal is suitably situated in a recess of the housing and, after the control element engages in detent fashion with the functional element, one of the two elements holds the O-ring snugly in the recess in the axial direction of its rotation axis. This embodiment also makes it possible to minimize friction forces and control forces.

According to another preferred embodiment of the invention, the functional element and the control element have complementary detent elements that engage each other in detent fashion; one of the detent elements suitably protrudes beyond a part of the functional element or control element that protrudes through the opening, thus also contributing to the reduction of the opening cross section.

According to another preferred embodiment of the invention, the functional element and the control element include rotation preventing elements that engage each other in a form-locked fashion and are advantageously spaced axially apart from the detent elements in the direction of a rotation axis of the functional element and control element so that during assembly, the rotation preventing elements engage each other in a form-locked fashion first, before the complementary detent elements engage each other in detent fashion.

The combination of features according to the invention also allows both the control element and the functional element to be manufactured in one piece out of plastic by means of injection molding, with the detent elements and the rotation preventing elements preferably being integrally formed onto or into the functional element and the control element, respectively.

### BRIEF DESCRIPTION OF THE DRAWINGS

The invention will be explained in greater detail below in conjunction with an exemplary embodiment shown in the drawings.

FIG. 1 is a perspective view of a rotary hammer;

FIG. 2 is a partially cut-away, enlarged detailed view of a part of a housing of the rotary hammer;

FIG. 3 is a sectional view along line III-III in FIG. 2;

FIG. 4 is an enlarged detailed view of section IV in FIG. 3, without the housing and seal;

FIG. 5 is a sectional view along line V-V in FIG. 4.

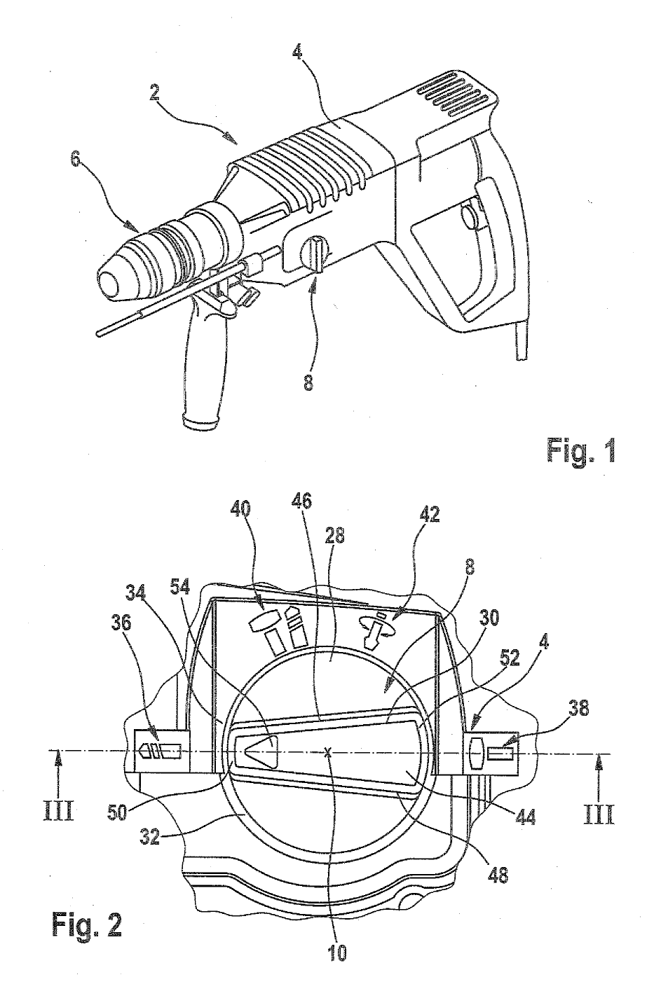

### EMBODIMENT OF THE INVENTION

The hand-guided power tool shown in the drawing and embodied in the form of a rotary hammer 2 is essentially composed of a housing 4, a tool holder 6 for holding an SDS drill bit, and a drive unit (not shown) that is enclosed by the housing 4 and is for driving the tool mounted in the tool holder 6 in a rotating and/or hammering fashion.

In order to select the respective operating mode of the rotary hammer 2 from among the alternatives of drilling with a purely rotating drive, hammer drilling with a combined rotating and hammering drive, chiseling with a purely hammering drive, and chiseling in an optimum, low-fatigue working position (Vario Lock), an operating mode selector switch in the form of a rotary knob 8 is mounted on one side of the housing 4; this selector switch can be rotated around a rotation axis 10 constituted by the center axis of the rotary knob 8 into four discrete switch positions and can be locked in the switch positions, each of which corresponds to one of the four above-mentioned operating modes.

The respective operating mode of the rotary hammer 2 is determined by the rotary position of a switch element 12, which is accommodated inside the housing 4 in the extension of the rotation axis 10 and whose rotation axis coincides with the rotation axis 10 of the rotary knob 8; this switch element 12 is connected to the rotary knob 8 in a rotationally fixed fashion through an opening 14 of the housing 4, in particular an opening of a transmission cover of the rotary hammer, so that the rotary position of the rotary knob 8 always corresponds to the rotary position of the switch element 12.

The opening 14 of the housing 4 has a circular opening cross section and is encompassed by a boundary edge that flares in stepped fashion toward the outside, yielding an annular housing recess 16 around the outer end of the opening 14, which recess serves as a seat for an O-ring seal 18. The O-ring seal 18 serves to prevent dust or other impurities from penetrating into the housing 4 of the rotary hammer 2 in the region of the operating mode selector switch. The boundary edge of the opening 14 protrudes slightly beyond the surrounding housing wall on the inside of the housing 4; four receiving pockets 22 (only one of which is visible in the drawing) are provided that are formed into the cylindrical outside of the protrusion 20. The receiving pockets 22 serve to receive a locking ball 24, which is integrated into the switch element 12 and is pressed radially against the protrusion 20 from the outside by a helical compression spring 26 likewise integrated into the switch element 12; in each of the four discrete switch positions of the rotary knob 8, the locking ball 24 travels partway into a respective one of the four receiving pockets 22 in order to thus lock the switch element 12 together with the rotary knob 8 in the respective switch position.

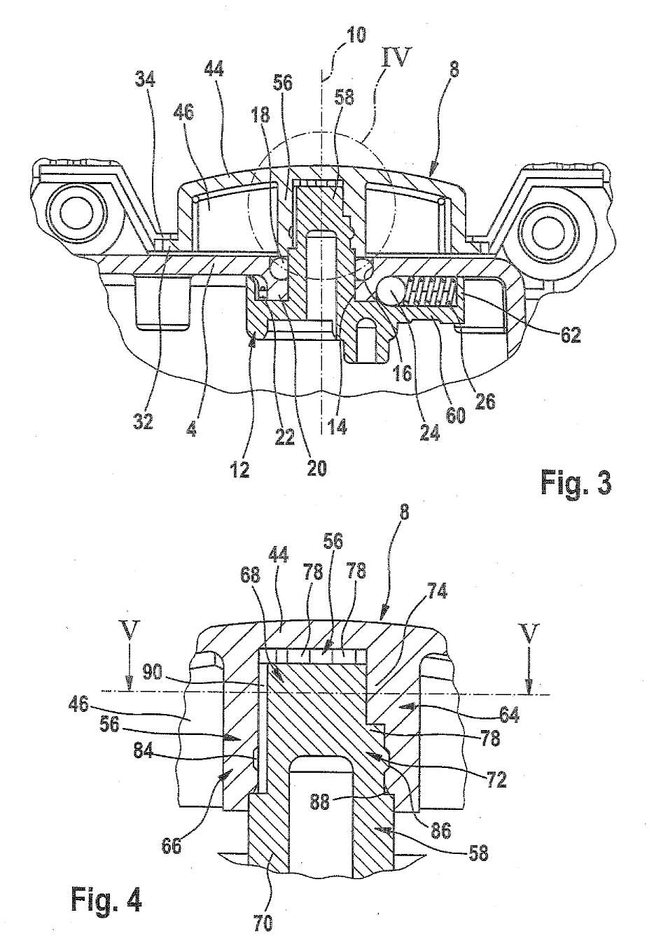

As is best depicted in FIG. 2, the rotary knob 8, which is manufactured in one piece out of plastic by means of injection molding, has a flat, disk-shaped lower part 28 with a circular outline from which an actuating protrusion 30 juts, which is oriented diametrically in relation to the outline. As shown in FIGS. 2 and 3, slightly more than half of an outer circumference edge 32 of the lower part 28 is overlapped by a part 34 of the housing 4 that is provided with four symbolic representations 36, 38, 40, 42 (FIG. 2) for the four switch positions, i.e. of the four operating modes drilling, chiseling, drilling and chiseling, and Vario Lock.

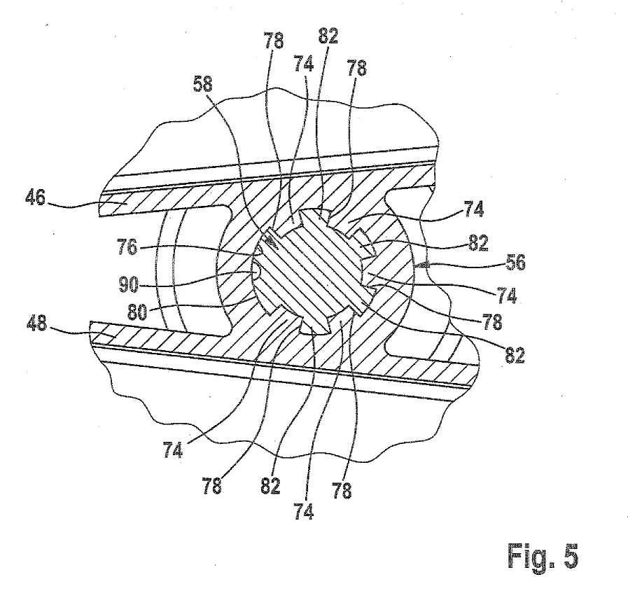

The actuating protrusion 30, which is embodied of one piece with the lower part 28, has a slightly convexly curved top wall 44, two longitudinal side walls 46, 48 spaced apart from each other and oriented at an acute angle to each other, and two rounded end walls 50, 52 that connect the longitudinal side walls 46, 48. An indicator arrow 54 is formed into the top surface of the top wall 44 and, together with the tapered form of the actuating protrusion 30, indicates the operating mode of the rotary hammer 2 that the operator has selected. The two longitudinal side walls 46, 48 of the actuating protrusion 30 are connected to each other by means of a receiving bushing 56 that is formed onto them, protrudes down from the bottom surface of the top wall 44, and opens toward the switch element 12, as is best depicted cross-sectionally in FIG. 4 and FIG. 5. The purpose of the bushing 56 is to receive a protruding part 58, which protrudes outward from the switch element 12 through the housing opening 14, whose engagement in the bushing 56 connects the switch element 12 and the rotary knob 8 to each other in a rotationally fixed, axially immobile fashion.

As is also best depicted in FIG. 3, the switch element 12, which is manufactured out of plastic by means of injection molding, has an essentially plate-shaped bottom part 60 that is of one piece with the upward-protruding, partially hollow protruding part 58. The bottom part 60 has an upturned outer circumference rim 62 whose outer circumference surface that is eccentric in relation to the rotation axis 10 forms a switching curve, which, in cooperation with switch components of the rotary hammer 2 that are not shown, executes the switching between operating modes. The locking ball 24 and the helical compression spring 26 are inserted in a radial guide in the bottom part 60.

As is best depicted in FIG. 4, the receiving bushing 56 has an upper rotation preventing section 64 adjoining the cover part 44 and a lower detent section 66 oriented toward the switch element 12, while the protruding part 58 of the switch element 12 correspondingly has a rotation preventing section 68 at its upper end and a detent section 72 that is situated between the rotation preventing section 68 and a base part 70 that passes through the opening 14. The two rotation preventing sections 64 and 68 engage each other in form-locked fashion and prevent the switching element 12 and the rotary knob 8 from rotating out of position in relation to each other, while the two detent sections 66, 72 engage each other in detent fashion and connect the rotary knob 8 to the switch element 12 in captive fashion in the axial direction of the rotation axis 10.

As is best depicted in FIG. 5, the rotation preventing section 64 of the receiving bushing 56 has a total of five longitudinal ribs 74 that are formed onto a boundary wall 76 and protrude radially inward in relation to the rotation axis from the inner, partially cylindrical boundary wall 76, while the part of the boundary wall 76 closest to the end wall 50 of the actuating protrusion 30 is not provided with a protruding longitudinal rib. In a corresponding fashion, the rotation preventing section 68 of the protruding part 58 is provided with five axial longitudinal grooves 78, which are complementary to the longitudinal ribs 74, are formed into a partially cylindrical circumference surface 80 of the protruding part 58, and are separated from one another in the circumference direction by ribs 82 with a dovetail-shaped cross section. The part of the circumference wall 76 closest to the end wall 50 of the actuating protrusion 30 is not provided with a longitudinal groove. The asymmetrical, nonuniform distribution of the longitudinal ribs 74 and longitudinal grooves 78 over the circumference of the rotation preventing sections 64, 68 of the receiving bushing 56 and the protruding part 58 allows the rotary knob 8 and switch element 12 to be connected to each other in only one orientation in which both the tapering actuating protrusion 30 and the arrow 54 point toward the position 36 (FIG. 2) 38, 40, or 42 associated with the switch position of the switch element 12.

The inner cylindrical boundary wall of the detent section 66 of the receiving bushing 56 has a circumferential detent groove 84 with a trapezoidal cross section formed into it, while the detent section 72 of the protruding part 58 is provided with a complementary detent bulge 86 that is trapezoidal in cross section and extends in the circumference direction around an essentially cylindrical outer circumference surface of the detent section 72.

To facilitate the detent engagement of the two detent sections 72 and 66, in the vicinity of its opening, the receiving bushing 56 is provided with a circumferential insertion bevel 88 for the detent bulge 86. In addition, the protruding part 58, on its side oriented toward the end wall 50, has an axial flute 90, which extends along the rotation preventing section 68 and detent section 72 and permits air to easily escape from the interior of the receiving bushing 56 as the protruding part 58 is being inserted into the receiving bushing 56.

During assembly of the rotary hammer 2, first the switch element 12 is inserted with the protruding part 58 through the opening 14 from the inside. Then, the O-ring seal 18 is slid on around the protruding part 58 from the outside and inserted into the housing recess 16. Finally, the rotary knob 8 is detachably fastened from the outside to the protruding part 58 of the switch element 12 in that first, the rotary knob 8 is brought into the correct rotary orientation in relation to the protruding part 58 in which the ribs 74 and the grooves 78 are able to engage with one another in form-locked fashion and then, the rotary knob 8 is slid axially toward the switch element 12 to produce the form-locked engagement between the ribs 74 and the grooves 78, and finally, a compressive force is exerted on the rotary knob 8 in the axial direction of the rotation axis 10 in order to snap the detent bulge 86 into the detent groove 84 and detachably connect the rotary knob 8 to the switch element 12.

1-10. (canceled)

11. An electrical device, in particular a hand-guided electrical power tool, comprising:
a housing;
a rotatable control element situated outside the housing; and
a functional element that is situated inside the housing and is connected to the control element in a rotationally fixed fashion, wherein the control element and the functional element are locked to each other in detent fashion through an opening of the housing.

12. The electrical device as recited in claim 11, wherein a part protrudes from either the functional element or the control element through the opening of the housing into a recess of the respective other control element or functional element and the part engages in detent fashion in the recess and secures the functional element and control element in a manner that prevents them from rotating in relation to each other.

13. The electrical device as recited in claim 12, wherein a protruding part of the functional element protrudes through the opening of the housing into a recess of the control element.

14. The electrical device as recited in claim 11, wherein the functional element and the control element include complementary detent elements that engage each other in detent fashion.

15. The electrical device as recited in claim 12, wherein the functional element and the control element include complementary detent elements that engage each other in detent fashion.

16. The electrical device as recited in claim 13, wherein the functional element and the control element include complementary detent elements that engage each other in detent fashion.

17. The electrical device as recited in claim 14, wherein one of the detent elements protrudes from the part of the functional element or fastening element that protrudes through the opening.

18. The electrical device as recited in claim 15, wherein one of the detent elements protrudes from the part of the functional element or fastening element that protrudes through the opening.

19. The electrical device as recited in claim 11, wherein the functional element and the control element include rotation preventing elements that engage each other in a form-locked fashion.

20. The electrical device as recited in claim 12, wherein the functional element and the control element include rotation preventing elements that engage each other in a form-locked fashion.

21. The electrical device as recited in claim 13, wherein the functional element and the control element include rotation preventing elements that engage each other in a form-locked fashion.

22. The electrical device as recited in claim 19, wherein the detent elements and the rotation preventing elements of the functional element and control element are situated spaced axially apart from each other in a direction of a rotation axis of the functional element and control element.

23. The electrical device as recited in claim 20, wherein the detent elements and the rotation preventing elements of the functional element and control element are situated spaced axially apart from each other in a direction of a rotation axis of the functional element and control element.

24. The electrical device as recited in claim 21, wherein the detent elements and the rotation preventing elements of the functional element and control element are situated spaced axially apart from each other in a direction of a rotation axis of the functional element and control element.

25. The electrical device as recited in claim 19, wherein when the functional element and control element are being connected to each other, the rotation preventing elements engage each other in a form-locked fashion before the detent elements engage each other in detent fashion.

26. The electrical device as recited in claim 20, wherein when the functional element and control element are being connected to each other, the rotation preventing elements engage each other in a form-locked fashion before the detent elements engage each other in detent fashion.

27. The electrical device as recited in claim 19, wherein the detent elements and the rotation preventing elements of the functional element and control element are formed onto the functional element and the control element, respectively, or are formed into the functional element and the control element, respectively.

28. The electrical device as recited in claim 20, wherein the detent elements and the rotation preventing elements of the functional element and control element are formed onto the functional element and the control element, respectively, or are formed into the functional element and the control element, respectively.

29. The electrical device as recited in claim 12, further comprising a seal that encompasses the part of the functional element or control element that protrudes through the opening of the housing.

30. The electrical device as recited in claim 13, further comprising a seal that encompasses the part of the functional element or control element that protrudes through the opening of the housing.
